(19) United States
(12) Patent Application Publication
(10) Pub. No.: US 2022/0186909 A1
(43) Pub. Date: Jun. 16, 2022

(54) Lens and Lamp with Lens Thereof

(71) Applicants: Wanjiong Lin, Ningbo (CN); Self Electronics Co., Ltd., Ningbo (CN); Self Electronics USA Corporation, Norcross, GA (US)

(72) Inventors: Zuping He, NINGBO (CN); Guoqing Zeng, NINGBO (CN); Xiaoyun Liu, NINGBO (CN); Kai Xu, NINGBO (CN); Jun Yang, NINGBO (CN)

(73) Assignees: Wanjiong Lin; Self Electronics Co., Ltd.; Self Electronics USA Corporation

(21) Appl. No.: 17/445,853

(22) Filed: Aug. 25, 2021

(30) Foreign Application Priority Data
Dec. 11, 2020 (CN) 202011447057.8

(51) Int. Cl. F21V 7/00; F21V 5/00

(52) U.S. Cl. CPC F21V 7/0091; F21V 5/00

(57) ABSTRACT

A lens has a light source setting location, first portion and second portion, the second portion has a first light inlet surface, first connection surface, first total reflection surface, second total reflection surface, third total reflection surface, and first light outlet surface being connected to the free end of the first total reflection surface and the third total reflection surface, and emitting the reflected light emitted from the third total reflection surface, and the maximum optical intensity direction of the second light beam emitted from the first light outlet surface intersects with the main optical axis. The lens and the lamp with the lens realizes uniform lighting in a large area on one side, and has small volume and high light efficiency.

### RELATED APPLICATION

This application claims priority to Chinese Patent Application No. CN 202011447057.8, filed on Dec. 11, 2020.

### FIELD OF THE TECHNOLOGY

The present invention relates to the field of lighting techniques, in particular a lens and a lamp with the lens.

### BACKGROUND

With the popularity of LED lamps, there are more and more occasions to start using LED lamps, such as bedroom, kitchen, living room and other Home lighting, and commercial lighting such as freezer, cold chain, shelf.

The LED chip is used as a point light source with certain light intensity distribution, but for practical use, focus or uniform illumination over a large area is required. Therefore, in the existing technology, optical elements are generally set in the LED chip light direction for secondary light distribution, so as to achieve the required light intensity distribution.

With the development of lighting technology, new requirements have also been put forward. In indoor lighting, especially in products such as freezers and shelves, which are often located in the corner, efficient single-side large-area lighting is required, and the volume is also required to be miniaturized. At this time, the existing lamps cannot meet the needs.

### BRIEF SUMMARY THE TECHNOLOGY

In view of this, the present invention provides a lens and a lamp with the lens to solve the above technical problems.

A lens includes:

a light source setting location, being with a main optical axis, a longitudinal axis, and a horizontal axis passing through its center and perpendicular to each other;

a first portion and second portion, located in the plane where the main optical axis and the horizontal axis are located, respectively, on both sides of the main optical axis; the light from the light source arranged at the light source setting location forms a first beam after the light distribution of the first portion, and the reverse extension line of the maximum light intensity direction of the first beam intersects the main optical axis;

the second portion includes:

a first light inlet surface;

a first connection surface, which is connected to an outer end of the first light inlet surface;

A first total reflection surface, being inclined outwardly relative to the main optical axis, which is used to reflect the incident light from the first light inlet surface outwardly;

a second total reflection surface, being inclined outwardly relative to the main optical axis, and one end is connected with the free end of the first connection surface for receiving and reflecting the reflected light from the first total reflection surface;

a third total reflection surface, being inclined inwardly inward relative to the main optical axis, and one end is connected with the free end of the second total reflection surface for completely reflecting the reflected light from the second total reflection surface;

and a first light outlet surface, being connected to the free end of the first total reflection surface and the third total reflection surface, and emitting the reflected light emitted from the third total reflection surface, and the maximum optical intensity direction of the second light beam emitted from the first light outlet surface intersects with the main optical axis.

advantageously, the first portion includes:

second light inlet surface;

a second connection surface, being connected with the outer end of the second light inlet surface;

a fourth total reflection surface, being inclined outwardly relative to the main optical axis, used to reflect the incident light from the second light inlet surface that is near the main optical axis to the outside;

a second light outlet surface, used for emitting the reflected light from the fourth total reflection surface to form a first light beam;

a fifth total reflection surface, being inclined outwardly relative to the main optical axis, and one end is connected with the free end of the second connection surface, and the incident light from the second light inlet surface that is away from the main optical axis is reflected to form a reflected light near the main optical axis;

And a third light outlet surface, located above the fifth total reflection surface for emitting the reflected light which is from the fifth total reflection surface to form a third beam.

advantageously, the first light inlet surface is a light gathering surface.

advantageously, part of the second light inlet surface which is near the main optical axis is a light gathering surface.

advantageously, the first total reflection surface is a curved surface that improves the consistency of the light beam.

advantageously, the fourth total reflection surface is a curved surface that improves the consistency of the light beam.

advantageously, the maximum light intensity directions of the second beam and the first beam are parallel or intersect at an angle less than 5°.

advantageously, the included angle between the reverse extension line of the maximum light intensity direction of the first beam intersects the main optical axis is 60° to 80°.

advantageously, the first portion and the second portion are integrally formed, and the connecting line is located at the main optical axis.

advantageously, the lens is a strip lens extending along the longitudinal axis.

A lamp includes a lamp holder, a lens, and a light source, the lens uses the lens as described above, the light source is arranged on the light source setting location.

advantageously, the lamp holder is a strip lamp holder along the longitudinal axis, the lens is a strip lens along a longitudinal axis, and the light source is a linear source along the longitudinal axis.

advantageously, the lamp further comprises a lamp cover arranged on the lamp holder and located above the lens.

advantageously, an optical film stretching the light from the light source along the longitudinal axis is arranged between the lens and the lamp cover.

The technical effects of the present invention:

The lens of the present invention and the lamp with the lens realizes uniform lighting in a large area on one side, and has small volume and high light efficiency.

### BRIEF DESCRIPTION OF THE DRAWINGS

Embodiments of the present invention will be described below with reference to the drawings, in which:

FIG. 1 is a three-dimensional structure diagram of the lens of the present embodiment.

FIG. 2 is a schematic structural view of the lens of the present embodiment.

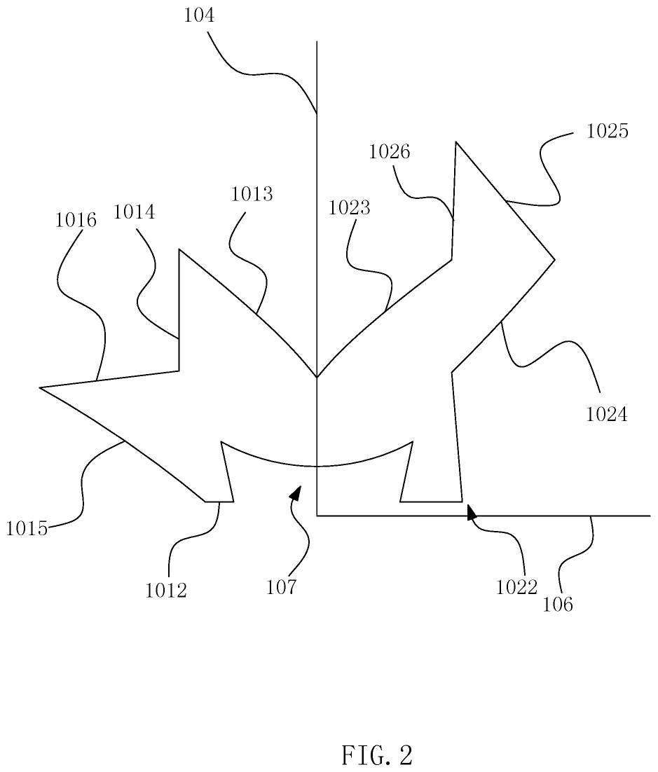

FIG. 3 is an optical path diagram of the lens of the present embodiment.

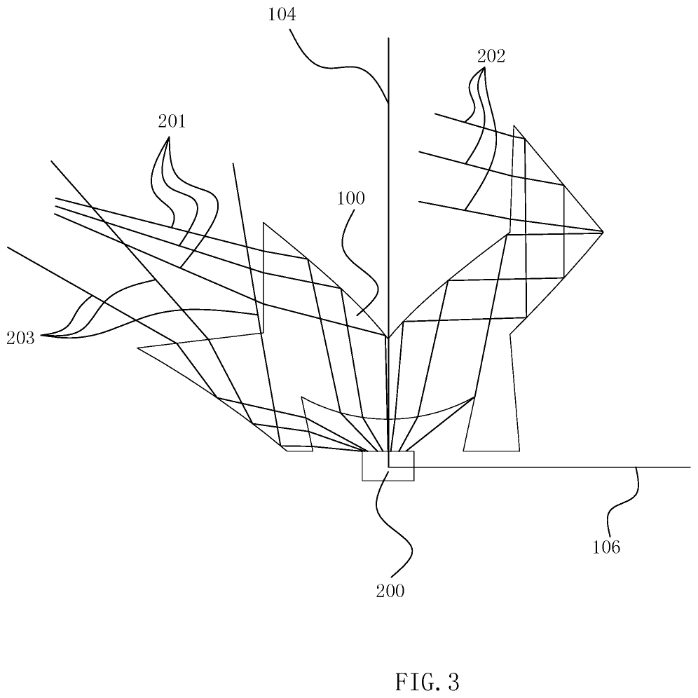

FIG. 4 is an optical path diagram of the lens of the present embodiment where the illumination surface is shown.

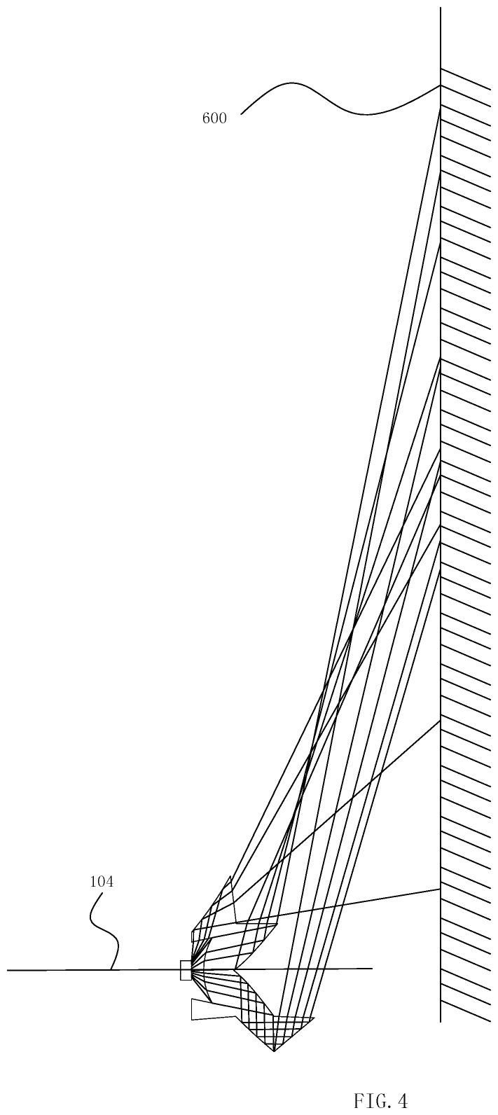

FIG. 5 is a structural diagram of the lamps of the present embodiment.

### DETAILED DESCRIPTION OF THE INVENTION

Specific embodiments of the present invention will be described in further detail below based on the drawings. It should be understood that the description of the embodiments of the present invention herein is not intended to limit the protection scope of the present invention.

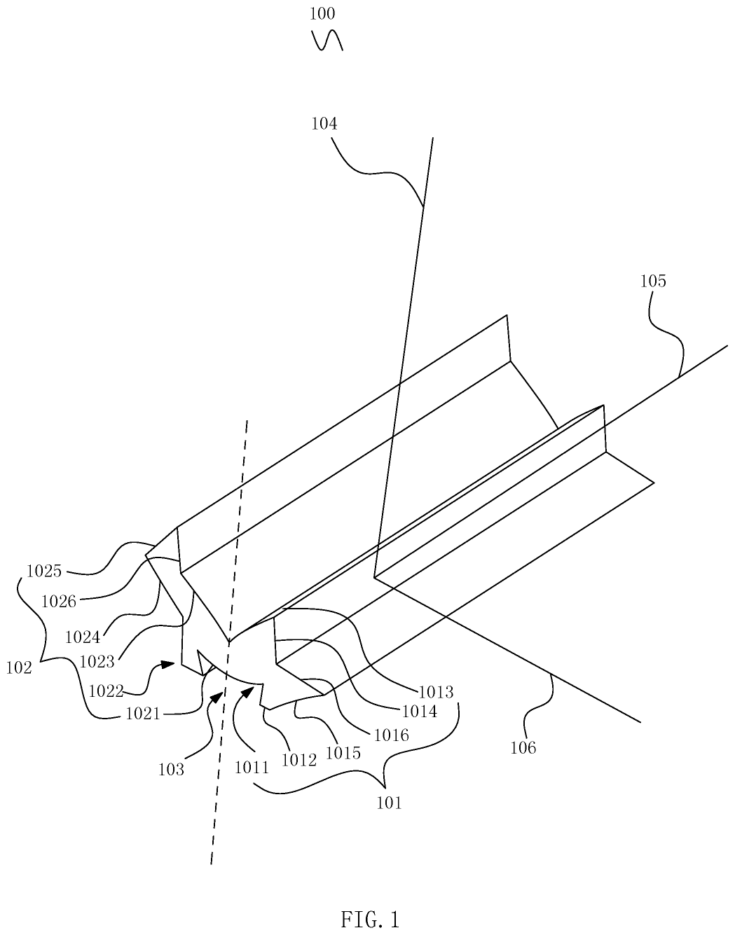

As shown in FIG. 1˜4, the lens 100 of the present embodiment includes a light source setting location 103, a first portion 101, and a second portion 102. The lens 100 is used to distribute the light from the light source 200, and the light source setting location 103 refers to the position where the light source 200 locates. Light source 200 has many types of light distribution, which can be a three-dimensional 360° luminescence, or a single three-dimensional 180° luminescence, or other angles. In order to achieve efficient and directional lighting, it is more advantageous to use a single three-dimensional 180° luminescence for secondary lighting. Therefore, the light source 200 in this embodiment is a single-sided, three-dimensional luminescence of 180°. At present the most common such light source 200 is an LED chip with a circuit board and its maximum light intensity direction is vertical to the circuit board. For convenience of description, the defined light source setting location 103 has a main optical axis 104, a longitudinal axis 105, and a horizontal axis 106 passing through its center and perpendicular to each other. In general, the light source 200 has a maximum light intensity direction that coincides with the main optical axis 104.

The lens 100 of the present invention is divided into the first portion 101 and the second portion 102, in the plane where the main optical axis 104 and the horizontal axis 106 are located, respectively, on both sides of the main optical axis 104. The light from the light source 200 arranged at the light source setting location 103 forms a first beam 201 after the light distribution of the first portion 101, and the reverse extension line of the maximum light intensity direction of the first beam 201 intersects the main optical axis 104. The first portion 101 deflects light from the light source 200 on its side thereof, and the deflection direction is away from the second portion 102. The specific shape and structure can be configured according to the desired deflection angle and beam angle.

When a high-efficiency single-side illumination is required, the second portion 102 deflects light from the light source 200 on its side, and the deflection direction is toward the first portion 101, and the second portion 102 including a first light inlet surface 1021, a first connection surface 1022, a first total reflection surface 1023, a second total reflection surface 1024, a third total reflection surface 1025, and a first light outlet surface 1026. The first light inlet surface 1021 receives the light beam from the light source 200, and the first connection surface 1022 is connected to the outer end of the first light inlet surface 1021. The first connection surface 1022 is used for transition and connection and does not participate in the main lighting distribution, and Its shape is related to the shape of other light surfaces; The first total reflection surface 1023 is arranged with an outward tilt relative to the main optical axis 104, which is used to reflect the incident light from the first light inlet surface 1011 outwardly. The consistency of the light beam from the light source 200 is not good, the first total reflection surface 1023 is a curved surface that improves the consistency of the light beam; the second total reflection surface 1024 is inclined outwardly relative to the main optical axis 104, and one end is connected with the free end of the first connection surface 1022 for receiving and completely reflecting the reflected light from the first total reflection surface 1023; the third total reflection surface 1025 is inclined inwardly inward relative to the main optical axis 104, and one end is connected with the free end of the second total reflection surface 1024 for completely reflecting the reflected light from the second total reflection surface 1024; part of the light beam from the light source 200 on the side where the second portion 102 is located is deflected by the three total reflection surfaces and emitted through the first light outlet surface 1026. The first light outlet surface 1026 is connected to the free end of the first total reflection surface 1023 and the third total reflection surface 1025, and the maximum optical intensity direction of the second light beam 202 emitted from the first light outlet surface 1026 intersects with the main optical axis 104.

The light inlet and outlet surfaces of the first portion 101 are both condenser surfaces and can also realize the deflection of the light beam, but not only uneven and the deflection angle cannot be very large, it is difficult to achieve a large range of lighting. In this embodiment, the first portion 101 includes a second light inlet surface 1011, a second connection surface 1012, a fourth total reflection surface 1013, a second light outlet surface 1014, a fifth total reflection surface 1015, and a third light outlet surface 1016. The second connection surface 1012 is connected with the outer end of the second light inlet surface 1011, similarly, the second connection surface 1012 is used for transition and connection, and does not participate in the main light distribution work, its shape is related to the shape of other light distribution surfaces; the fourth total reflection surface 1013 is inclined outwardly relative to the main optical axis 104, and is used to reflect the incident light from the second light inlet surface 1021 that is near the main optical axis 104 to the outside. In order to make the light more consistent, more uniform on the irradiation surface, the fourth total reflection surface 1013 is a curved surface to improve the consistency of the light beam; the second light outlet surface 1014 is used for emitting the reflected light from the fourth total reflection surface 1013 to form a first light beam 201; The fifth total reflection surface 1015 is inclined outwardly relative to the main optical axis 104, and one end is connected with the free end of the second connection surface 1012, and the incident light from the second light inlet surface 1021 that is away from the main optical axis 104 is reflected to form a reflected light near the main optical axis 104; A third light outlet surface 1016 is located above the fifth total reflection surface 1015 for emitting the reflected light which is from the fifth total reflection surface 1015 to form a third light beam 203. The first portion 101 deflects the incident light near the main optical axis 104 outward to obtain the first beam 201, which is used for large-area illumination and can achieve large angle deflection through total reflection. In addition, in order to compensate for the illumination of lens 100 in the direction of main optical axis 104, in this embodiment, Incident light from the second light inlet surface 1021 away from the main optical axis 104 is reflected through the fifth total reflection surface 1015.

In order to increase the light efficiency, in the present embodiment, the first light inlet surface 1021 is a light gathering surface. The second light inlet surface 1011 near the main optical axis 104 is a light gathering surface, and the part away from the main optical axis 104 is the side wall of the counter bore 107. The arrangement of the counter bore 107 can improve the light efficiency, which is not described in conventional settings.

In order to improve optical efficiency, in this embodiment, the maximum intensity directions of the second beam 202 and the first beam 201 are parallel or intersect at an Angle less than 5°.

The included angle between the reverse extension line of the maximum light intensity direction of the first beam 201 intersects the main optical axis 104 is 60° to 80°.

In order to facilitate manufacturing and light distribution calculation, the first portion 101 and the second portion 102 are integrally formed in this embodiment, and the connecting line is located at the main optical axis 104.

For the illumination surface 600, the lens 100 of the present embodiment is employed and a wide range of uniform illumination is obtained in one side.

The invention is mainly used for light distribution of line light source, and the lens 100 is a strip lens extending along the longitudinal axis 105.

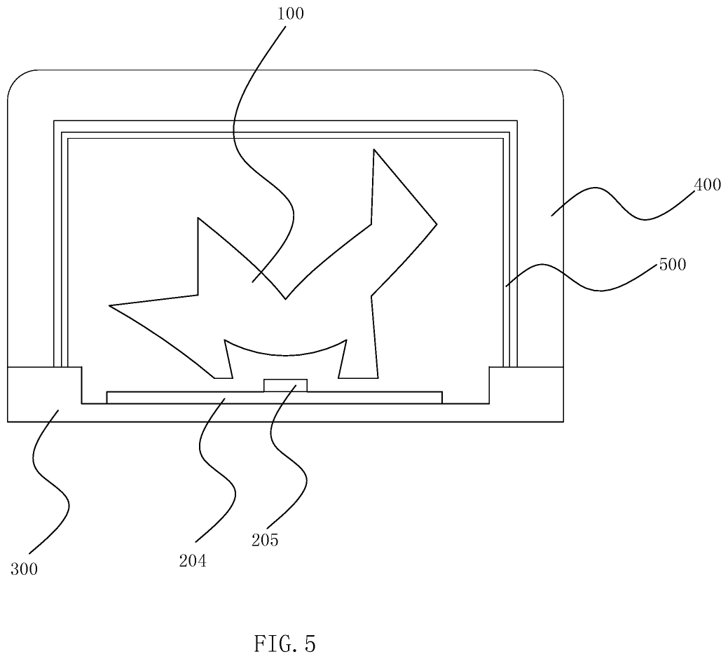

As shown in FIG. 5, the lamp in this embodiment includes a lamp holder 300, a lens 100 and a light source 200, and the light source 200 is arranged on the light source setting location 103. The lamp holder 300 is a strip lamp holder extending along the longitudinal axis 105, the lens 100 is a strip lens extending along the longitudinal axis 105, and the light source 200 is a linear light source extending along the longitudinal axis 105. The lamp also includes a lamp cover 400 arranged on the lamp holder 300 and located above the lens 100. An optical film 500 stretching the light from the light source 200 along the longitudinal axis 105 is arranged between the lens 100 and the lamp cover 400. The light source 200 includes a strip circuit board 204 extending along the longitudinal axis 105 and a plurality of LED chips 205 arranged on the strip circuit board 204.

The above are only preferred embodiments of the present invention, and are not used to limit the protection scope of the present invention. Any modification, equivalent replacement or improvement within the spirit of the present invention is covered by the scope of the claims of the present invention.

What is claimed is:

1. A lens (100), comprising:
light source setting location (103), being with a main optical axis (104), a longitudinal axis (105), and a horizontal axis (106) passing through its center and perpendicular to each other;
first portion (101) and second portion (102), located in the plane where the main optical axis (104) and the horizontal axis (106) are located, respectively, on both sides of the main optical axis 104; the light from the light source (200) arranged at the light source setting location (103) forms a first beam (201) after the light distribution of the first portion (101), and the reverse extension line of the maximum light intensity direction of the first beam (201) intersects the main optical axis (104);
characterized in that, the second portion (102) comprises:
first light inlet surface (1021);
first connection surface (1022), which is connected to an outer end of the first light inlet surface (1021);
first total reflection surface (1023), being inclined outwardly relative to the main optical axis (104), which is used to reflect the incident light from the first light inlet surface (1011) outwardly;
second total reflection surface (1024), being inclined outwardly relative to the main optical axis (104), and one end is connected with the free end of the first connection surface (1022) for receiving and reflecting the reflected light from the first total reflection surface (1023);
third total reflection surface (1025), being inclined inwardly inward relative to the main optical axis (104), and one end is connected with the free end of the second total reflection surface (1024) for completely reflecting the reflected light from the second total reflection surface (1024);
and first light outlet surface (1026), being connected to the free end of the first total reflection surface (1023) and the third total reflection surface (1025), and emitting the reflected light emitted from the third total reflection surface (1025), and the maximum optical intensity direction of the second light beam (202) emitted from the first light outlet surface (1026) intersects with the main optical axis (104).

2. A lens (100) as claimed in claim 1, wherein the first portion (101) comprises:
second light inlet surface (1011);
second connection surface (1012), being connected with the outer end of the second light inlet surface (1011);
fourth total reflection surface (1013), being inclined outwardly relative to the main optical axis (104), used to reflect the incident light from the second light inlet surface (1021) that is near the main optical axis (104) to the outside;
a second light outlet surface (1014), used for emitting the reflected light from the fourth total reflection surface (1013) to form a first light beam (201);
fifth total reflection surface (1015), being inclined outwardly relative to the main optical axis (104), and one end is connected with the free end of the second connection surface (1012), and the incident light from the second light inlet surface (1021) that is away from the main optical axis (104) is reflected to form a reflected light near the main optical axis (104);
and third light outlet surface (1016), located above the fifth total reflection surface (1015) for emitting the reflected light which is from the fifth total reflection surface (1015) to form a third beam (203).

3. A lens (100) as claimed in claim 1, wherein the first light inlet surface (1021) is a light gathering surface.

4. The lens (100) as claimed in claim 1, wherein part of the second light inlet surface (1011) which is near the main optical axis (104) is a light gathering surface.

5. The lens (100) as claimed in claim 1, wherein the first total reflection surface (1023) is a curved surface that improves the consistency of the light beam.

6. The lens (100) as claimed in claim 1, wherein the fourth total reflection surface (1013) is a curved surface that improves the consistency of the light beam.

7. A lens (100) as claimed in claim 1, wherein the maximum light intensity directions of the second beam (202) and the first beam (201) are parallel or intersect at an angle less than 5°.

8. The lens (100) as claimed in claim 1, wherein the included angle between the reverse extension line of the maximum light intensity direction of the first beam (201) intersects the main optical axis (104) is 60° to 80°.

9. The lens (100) as claimed in claim 1, wherein the first portion (101) and the second portion (102) are integrally formed, and the connecting line is located at the main optical axis (104).

10. A lens (100) as claimed in claim 1, wherein the lens (100) is a strip lens extending along the longitudinal axis (105).

11. A lamp, comprising a lamp holder (300), a lens (100), and a light source (200), characterized in that the lens (100) uses the lens (100) as claimed in claim 1, the light source (200) is arranged on the light source setting location (103).

12. The lamp as claimed in claim 11, wherein the lamp holder (300) is a strip lamp holder along the longitudinal axis (105), the lens (100) is a strip lens along a longitudinal axis (105), and the light source (200) is a linear source along the longitudinal axis (105).

13. The lamp as claimed in claim 11, wherein the lamp further comprises a lamp cover (400) arranged on the lamp holder (300) and located above the lens (100).

14. The lamp as claimed in claim 11, wherein an optical film (500) stretching the light from the light source (200) along the longitudinal axis (105) is arranged between the lens (100) and the lamp cover (400).
